(19) United States
(12) Patent Application Publication
(10) Pub. No.: US 2026/0312325 A1
(43) Pub. Date: Oct. 8, 2026

(54) ELECTRICAL CONNECTOR

(71) Applicant: CHENG UEI PRECISION INDUSTRY CO., LTD., New Taipei City (TW)

(72) Inventors: CHUAN-HUNG LIN, New Taipei City (TW); PEI-YI LIN, New Taipei City (TW); SHENG-NAN YU, New Taipei City (TW)

(21) Appl. No.: 19/312,229

(22) Filed: Aug. 27, 2025

(30) Foreign Application Priority Data
Apr. 2, 2025 (CN) 202520614878.8

(51) Int. Cl. H01R 13/424; H01R 13/03; H01R 13/24; H01R 13/506; H01R 13/6471; H01R 12/72

(52) U.S. Cl. CPC H01R 13/424; H01R 13/03; H01R 13/2442; H01R 13/506; H01R 13/6471; H01R 12/721

(57) ABSTRACT

An electrical connector includes an insulating housing, a terminal assembly fastened in the insulating housing, and a conductive glue body disposed in a middle of the terminal assembly. The terminal assembly includes a plurality of signal terminals and a plurality of grounding terminals. Each grounding terminal has a first curve portion and a second curve portion. Top ends of two opposite outer surfaces of the conductive glue body protrude outward to form a plurality of upper convex portions. Bottom ends of the two opposite outer surfaces of the conductive glue body protrude outward to form a plurality of lower convex portions. The first curve portions of the plurality of the grounding terminals are electrically connected with the plurality of the upper convex portions. The second curve portions of the plurality of the grounding terminals are electrically connected with the plurality of the lower convex portions.

### CROSS REFERENCE TO RELATED APPLICATIONS

The present application is based on, and claims priority from, China Patent Application No. 202520614878.8, filed Apr. 2, 2025, the disclosure of which is hereby incorporated by reference herein in its entirety.

### BACKGROUND OF THE INVENTION

### Field of the Invention

The present invention generally relates to an electrical connector, and more particularly to an electrical connector improving a high-frequency signal transmission.

### Description of Related Art

With the development of sciences and technologies, a higher transmission performance needs a greater number of signal terminals to proceed with a transmission. In that case, a structure of an electrical connector becomes larger, and the electrical connector limits a product integration development and a miniaturization development. At the same time, terminals of the electrical connector with smaller structures and higher transmission densities are easily interfered with one another, so a signal transmission is incomplete.

A conventional electrical connector with a conductive plastic element includes an insulating housing, a terminal base, a plurality of signal terminals, a plurality of grounding terminals and a conductive plastic element. The plurality of the signal terminals and the plurality of the grounding terminals are fastened in the terminal base. The plurality of the signal terminals, the plurality of the grounding terminals and the terminal base are fastened in the insulating housing. An accommodating space is formed at a front end of the insulating housing. Rear ends of the plurality of the signal terminals and rear ends of the plurality of the grounding terminals are exposed out of a rear end of the insulating housing. Features of the conventional electrical connector with the conductive plastic element are described as follows. The conductive plastic element is disposed in the terminal base. A partial area of the conductive plastic element is exposed out of the terminal base, and the partial area of the conductive plastic element abuts against the plurality of the grounding terminals. When the electrical connector operates under a high-frequency and high-speed transmission condition, the electrical connector achieves a greater stability by use of a structure of the conductive plastic element.

However, a plurality of extending portions of the conductive plastic element are surrounded by the insulating housing. When high-frequency signals are transmitted, an internal structure of the electrical connector makes an electromagnetic field generate a resonance, a high-frequency characteristic is particularly poor in a certain frequency band, and an impedance is mismatched, so an insertion loss and a reflection loss of a signal become worse to affect crosstalk results. When the high-frequency signals are transmitted, the above-mentioned phenomenon will be more serious, so that signal transmission quality of the electrical connector is further affected.

Thus, it is essential to provide an innovative electrical connector improving a high-frequency signal transmission.

### BRIEF SUMMARY OF THE INVENTION

An object of the present invention is to provide an electrical connector improving a high-frequency signal transmission. The electrical connector has an insulating housing, a terminal assembly and a conductive glue body. The terminal assembly is fastened in the insulating housing. The terminal assembly includes a dielectric body, a plurality of signal terminals and a plurality of grounding terminals fastened in the dielectric body. Each grounding terminal has a contacting portion, a top portion, a first curve portion, a base portion, a second curve portion and a soldering portion. The contacting portion and the top portion extend out of a top end of the dielectric body. The first curve portion and the base portion are fastened in the dielectric body. The second curve portion and the soldering portion extend out of a bottom end of the dielectric body. Several portions of two top ends of two inner surfaces of the dielectric body are recessed oppositely to form a plurality of assembling holes. The conductive glue body is disposed in a middle of the terminal assembly. Top ends of two opposite outer surfaces of the conductive glue body protrude outward to form a plurality of upper convex portions. Bottom ends of the two opposite outer surfaces of the conductive glue body protrude outward to form a plurality of lower convex portions. The plurality of the upper convex portions are fastened in the plurality of the assembling holes. The plurality of the lower convex portions are disposed under the dielectric body. The plurality of the first curve portions of the plurality of the grounding terminals are electrically connected with the plurality of the upper convex portions. The plurality of the second curve portions of the plurality of the grounding terminals are electrically connected with the plurality of the lower convex portions.

Another object of the present invention is to provide an electrical connector. The electrical connector includes an insulating housing, a terminal assembly disposed in the insulating housing, and a conductive glue body. The terminal assembly includes a dielectric body, a plurality of signal terminals and a plurality of grounding terminals fastened in the dielectric body. Each grounding terminal has a contacting portion, a top portion, a first curve portion, a base portion, a second curve portion and a soldering portion. The contacting portion and the top portion extend out of a top end of the dielectric body. The first curve portion and the base portion are fastened in the dielectric body. The second curve portion and the soldering portion extend out of a bottom end of the dielectric body. The conductive glue body is disposed in a middle of the terminal assembly. The conductive glue body has a base body. Two opposite sides of a top surface of the base body extend upward to form a plurality of column portions. Top ends of the outer surfaces of the plurality of the column portions which are corresponding to the plurality of the grounding terminals protrude outward to form a plurality of upper convex portions. Bottom ends of the two opposite outer surfaces of the base body extend outward to form a plurality of lower convex portions. The plurality of the upper convex portions are fastened in the dielectric body. The plurality of the lower convex portions are disposed under the dielectric body. The plurality of the first curve portions of the plurality of the grounding terminals are electrically connected with the plurality of the upper convex portions. The plurality of the second curve portions of the plurality of the grounding terminals are electrically connected with the plurality of the lower convex portions.

Another object of the present invention is to provide an electrical connector. The electrical connector has an insulating housing, a terminal assembly disposed in the insulating housing, a conductive glue body and a supporting body. The terminal assembly includes a dielectric body, a plurality of signal terminals and a plurality of grounding terminals fastened in the dielectric body. Each grounding terminal and each signal terminal have a fastening portion, a bending portion, a connecting portion, a contacting portion, a soldering portion. The bending portion, the connecting portion and the contacting portion extend out of a top end of the dielectric body. The fastening portion is fastened in the dielectric body. A bottom of the fastening portion and the soldering portion extend out of a bottom end of the dielectric body. The conductive glue body is disposed in a middle of the terminal assembly. Top ends of two opposite outer surfaces of the conductive glue body protrude outward to form a plurality of upper convex portions. Bottom ends of the two opposite outer surfaces of the conductive glue body protrude outward to form a plurality of lower convex portions. The plurality of the upper convex portions are fastened in the dielectric body. The plurality of the lower convex portions are disposed under the dielectric body. Tops of the fastening portions of the plurality of the grounding terminals are electrically connected with the plurality of the upper convex portions. The bottoms of the fastening portions of the plurality of the grounding terminals are electrically connected with the plurality of the lower convex portions. The supporting body is disposed to a bottom of the conductive glue body. The supporting body is disposed to a bottom end of the terminal assembly. A bottom surface of the dielectric body is spaced from a top surface of the supporting body to form a mounting space between the bottom surface of the dielectric body and the top surface of the supporting body. The plurality of the lower convex portions are disposed in the mounting space.

As described above, the electrical connector improves a high-frequency characteristic of the electrical connector by structure designs of a plurality of differential terminal assemblies. A bottom end of a bending portion of each grounding terminal extends downward to form the top portion. The top portion extends out of a top end of an insulating body of the dielectric body. A bottom end of the top portion is connected with the first curve portion. The first curve portion is disposed in the insulating body of the dielectric body. A bottom end of the first curve portion is connected with the base portion. The base portion is disposed in the insulating body of the dielectric body. A bottom end of the base portion is connected with the second curve portion. The second curve portion extends out of a bottom end of the insulating body. A bottom end of the second curve portion extends downward to form the soldering portion. In addition, the electrical connector improves the high-frequency characteristic by a structure design of the conductive glue body. The conductive glue body has the plurality of the upper convex portions and the plurality of the lower convex portions. The plurality of the first curve portions of the plurality of the grounding terminals are electrically connected with the plurality of the upper convex portions, so the high-frequency characteristic of the electrical connector is improved. The plurality of the second curve portions of the plurality of the grounding terminals are electrically connected with the plurality of the lower convex portions, so the high-frequency characteristic of the electrical connector is improved.

### BRIEF DESCRIPTION OF THE DRAWINGS

The present invention will be apparent to those skilled in the art by reading the following description, with reference to the attached drawings, in which:

FIG. 1 is a perspective view of an electrical connector in accordance with a preferred embodiment of the present invention;

FIG. 2 is a partially exploded view of the electrical connector of FIG. 1;

FIG. 3 is an enlarged view of an encircled portion X1 of the electrical connector of FIG. 2;

FIG. 4 is a diagrammatic drawing of the electrical connector of FIG. 1;

FIG. 5 is a sectional diagram of the electrical connector along a line V-V of FIG. 4;

FIG. 6 is another partially exploded view of the electrical connector of FIG. 1;

FIG. 7 is an enlarged view of an encircled portion X2 of the electrical connector of FIG. 6;

FIG. 8 is one more partially exploded view of the electrical connector of FIG. 1;

FIG. 9 is an exploded view of a terminal assembly of the electrical connector according to the present invention; and

FIG. 10 is another exploded view of the terminal assembly of the electrical connector of FIG. 9.

### DETAILED DESCRIPTION OF THE INVENTION

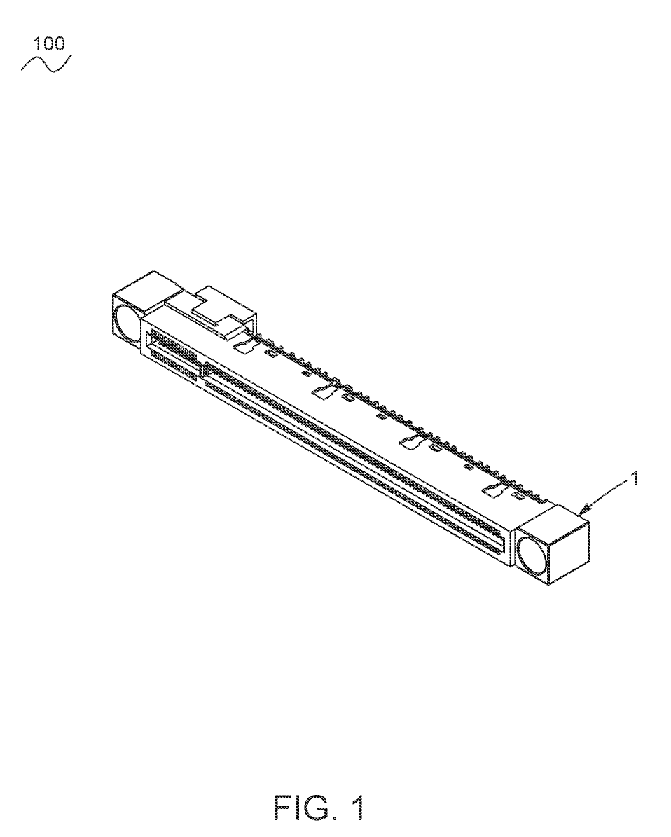

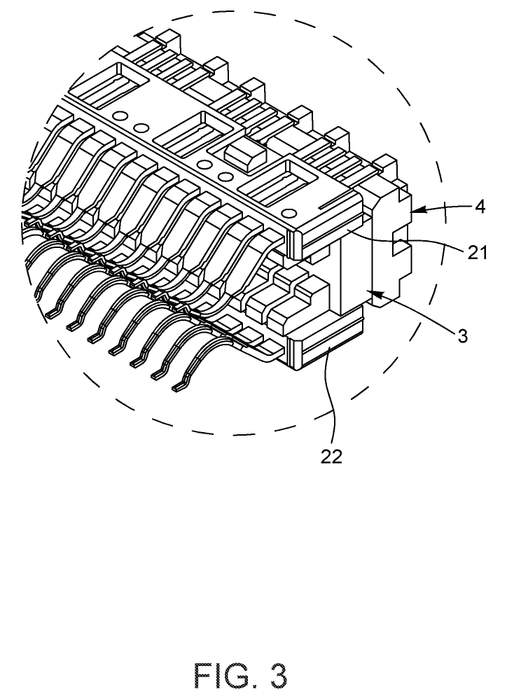

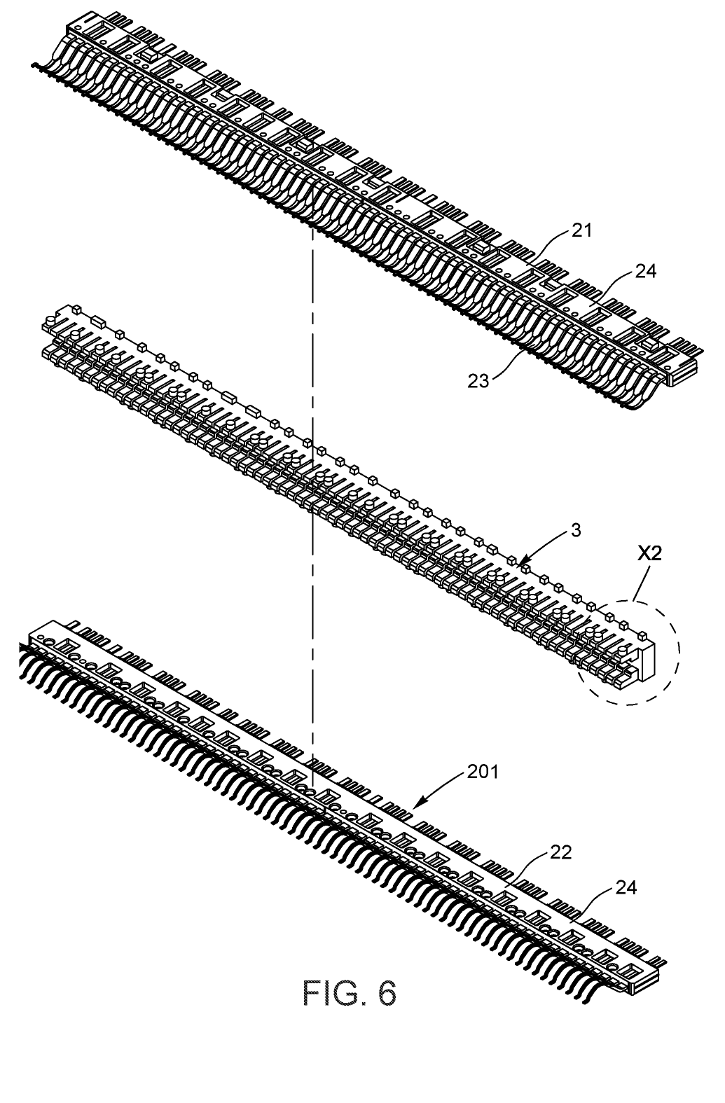

With reference to FIG. 1 to FIG. 7, an electrical connector 100 in accordance with a preferred embodiment of the present invention is shown. The electrical connector 100 includes an insulating housing 1, a terminal assembly 2 disposed in the insulating housing 1, a conductive glue body 3 and a supporting body 4.

The terminal assembly 2 and the conductive glue body 3 are fastened in the insulating housing 1. The supporting body 4 is exposed out of a bottom surface of the insulating housing 1. The conductive glue body 3 is disposed in a middle of the terminal assembly 2. The supporting body 4 is disposed to a bottom surface of the conductive glue body 3. The supporting body 4 is disposed to a middle of a bottom end of the terminal assembly 2.

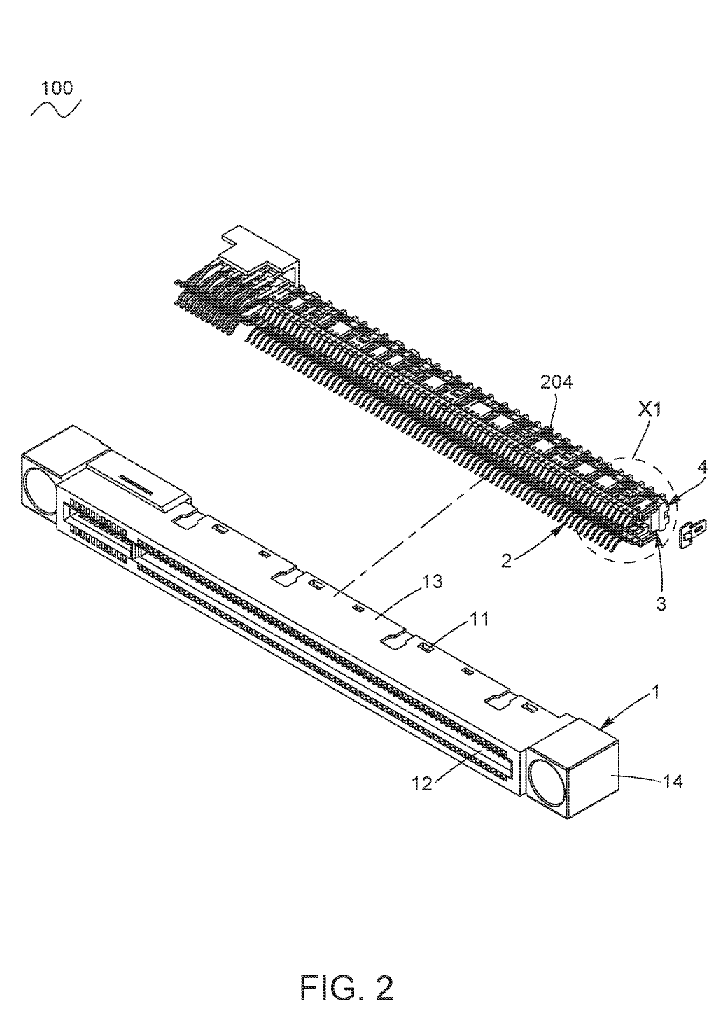

Referring to FIG. 2, the insulating housing 1 has two opposite long side walls 13 and two opposite short side walls 14. Each long side wall 13 defines a plurality of openings 11 penetrating through two opposite sides of the long side wall 13. Corresponding mechanisms of the terminal assembly 2 are disposed in the plurality of the openings 11 to realize that the terminal assembly 2 is located in the insulating housing 1, and that the terminal assembly 2 is fastened in the insulating housing 1. The two long side walls 13 are disposed along a longitudinal direction. Two facing surfaces of the two long side walls 13 are spaced from each other to form an inserting slot 12 between the two long side walls 13 of the insulating housing 1. The inserting slot 12 is docked with a circuit board (not shown) of a cable connector (not shown).

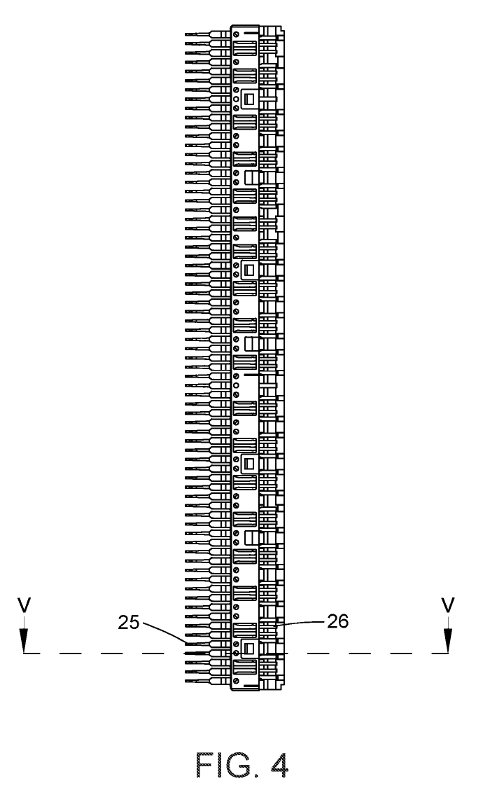

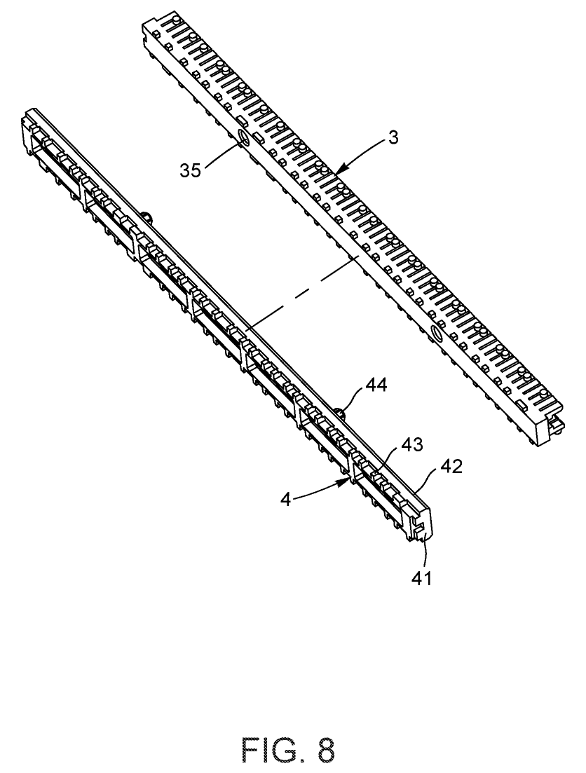

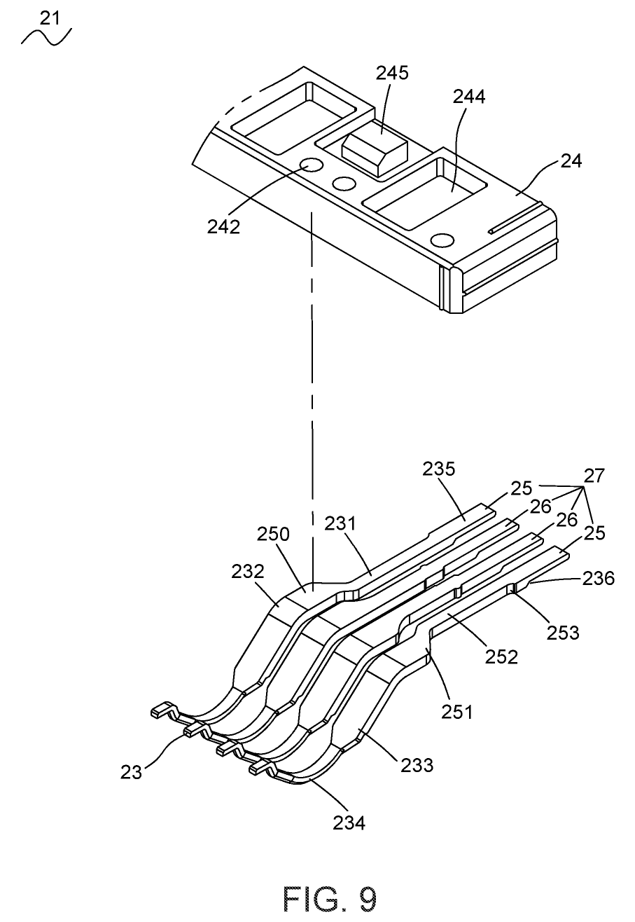

Referring to FIG. 4 to FIG. 9, the terminal assembly 2 includes a dielectric body 204, a plurality of signal terminals 26 and a plurality of grounding terminals 25 fastened in the dielectric body 204. Each two adjacent signal terminals 26 are located between two grounding terminals 25. The dielectric body 204 includes two insulating bodies 24. The terminal assembly 2 has two terminal modules 201 longitudinally arranged into two rows. The two terminal modules 201 include a first terminal module 21 and a second terminal module 22. The conductive glue body 3 is disposed between the two terminal modules 201. The conductive glue body 3 is mounted between the first terminal module 21 and the second terminal module 22.

In the preferred embodiment, the electrical connector 100 is a PCIe (Peripheral Component Interconnect Express) female connector. A structure of the second terminal module 22 is roughly the same as a structure of the first terminal module 21. The second terminal module 22 and the first terminal module 21 are longitudinally disposed in a mirror image way. Therefore, the first terminal module 21 is specifically described in the following description of the preferred embodiment.

Each terminal module 201 includes a plurality of terminals 23 and an insulating body 24. The plurality of the terminals 23 are fastened in the insulating body 24. Each terminal 23 has a fastening portion 231, a bending portion 232, a connecting portion 233, a contacting portion 234, a soldering portion 235 and an inclining portion 236. The fastening portion 231 is fastened in the insulating body 24. A top end of the fastening portion 231 is bent inward to form the bending portion 232. The bending portion 232 extends out of a top end of the insulating body 24. A top end of the bending portion 232 slantwise extends inward and upward to form the connecting portion 233. The top end of the bending portion 232 slantwise extends upward and towards the inserting slot 12 of the insulating housing 1 to form the connecting portion 233.

A top end of the connecting portion 233 is arched inward to form the contacting portion 234. The top end of the connecting portion 233 is arched towards the inserting slot 12 of the insulating housing 1 to form the contacting portion 234. The contacting portion 234 is inserted into the inserting slot 12, and then the contacting portion 234 abuts against the circuit board (not shown) of the cable connector (not shown). A bottom end of the fastening portion 231 extends downward to form the soldering portion 235. The soldering portions 235 of the two terminal modules 201 are disposed to two opposite surfaces of the supporting body 4. A bottom end of an inner surface of the soldering portion 235 is recessed outward and opposite to the supporting body 4, and then slantwise extends inward and upward to form the inclining portion 236. The soldering portion 235 becomes thinner by the inclining portion 236, so a high-frequency characteristic of the electrical connector 100 is improved.

The plurality of the terminals 23 has a plurality of differential terminal assemblies 27 abreast arranged transversely. Each differential terminal assembly 27 has two grounding terminals 25 and two adjacent signal terminals 26. The two adjacent signal terminals 26 are disposed between the two grounding terminals 25. The fastening portion 231 of each grounding terminal 25 has a top portion 250, a first curve portion 251, a base portion 252 and a second curve portion 253. The base portion 252 is shown as an elongated shape. The base portion 252 is disposed along an up-down direction. The base portion 252 is fastened in the insulating body 24. A bottom end of the base portion 252 extends downward to form the soldering portion 235.

In the preferred embodiment, the bottom end of the base portion 252 extends downward and protrudes outward to form the second curve portion 253. A bottom end of the second curve portion 253 extends downward to form the soldering portion 235. The second curve portion 253 is connected between the base portion 252 and the soldering portion 235, so a width of the soldering portion 235 is wider than a width of the base portion 252. A top end of the base portion 252 is bent outward and then extends upward to form the first curve portion 251. The first curve portion 251 is fastened in the insulating body 24. A width of the first curve portion 251 is wider than the width of the base portion 252. Each grounding terminal 25 has the contacting portion 234, the top portion 250, the first curve portion 251, the base portion 252, the second curve portion 253 and the soldering portion 235. The contacting portion 234 and the top portion 250 extend out of a top end of the dielectric body 204. The first curve portion 251 and the base portion 252 are fastened in the dielectric body 204. The second curve portion 253 and the soldering portion 235 extend out of a bottom end of the dielectric body 204.

In the preferred embodiment, the first curve portion 251 is shown as a trapezoidal shape. A transverse width of a bottom of the first curve portion 251 is narrower than a transverse width of a top of the first curve portion 251. A top end of the first curve portion 251 extends upward to form the top portion 250. The top portion 250 extends out of the top end of the insulating body 24. A width of the top portion 250 is wider than the width of the first curve portion 251. The width of the top portion 250 is wider than the width of the base portion 252. The width of the top portion 250 is wider than the width of the soldering portion 235. The width of the top portion 250 is equal with a width of the connecting portion 233.

In the preferred embodiment, the top portion 250 extends out of the top end of the insulating body 24. The first curve portion 251 and the base portion 252 are fastened in the insulating body 24. The first curve portion 251 is disposed to an outside of a corresponding mechanism of the conductive glue body 3. The first curve portion 251 is electrically connected with the corresponding mechanism of the conductive glue body 3, so the high-frequency characteristic of the electrical connector 100 is improved. The second curve portion 253 is disposed to the outside of the corresponding mechanism of the conductive glue body 3. The second curve portion 253 is electrically connected with the corresponding mechanism of the conductive glue body 3, so the high-frequency characteristic of the electrical connector 100 is improved.

The fastening portion 231 of each signal terminal 26 has an expanding portion 261, a main body 262, a first narrowing portion 263 and a second narrowing portion 264. A top end of the main body 262 of the fastening portion 231 of each signal terminal 26 is extended outward, and then extends upward and protrudes outward to form the expanding portion 261. The expanding portion 261 and the first curve portion 251 of the grounding terminal 25 are aligned along a transverse direction.

Two facing edges of two bottom ends of the two main bodies 262 of the two fastening portions 231 of the two signal terminals 26 are recessed oppositely and extend downward to form two first narrowing portions 263. The two first narrowing portions 263 are used for improving the high-frequency characteristic of the electrical connector 100. Two facing edges of two bottom ends of the two first narrowing portions 263 are recessed oppositely and extend downward to form two second narrowing portions 264. The two second narrowing portions 264 are used for improving the high-frequency characteristic of the electrical connector 100.

A bottom end of each second narrowing portion 264 extends downward to form the soldering portion 235. The first narrowing portion 263 and the second narrowing portion 264 of each signal terminal 26 are aligned an upper portion of the second curve portion 253 of each grounding terminal 25. The plurality of the second curve portions 253 of the plurality of the terminals 23 are located to outer sides of the first narrowing portions 263 and the second narrowing portions 264 of the plurality of the terminals 23.

A middle of an outer surface of the fastening portion 231 of each signal terminal 26 protrudes outward to form a protrusion 265. The two protrusions 265 of the two signal terminals 26 protrude oppositely. The two protrusions 265 of the two signal terminals 26 face towards the two grounding terminals 25. The protrusion 265 is fastened in the insulating body 24 of the dielectric body 204. The protrusion 265 prevents each signal terminal 26 from breaking away from the insulating body 24. The two protrusions 265 are disposed to two outer sides of the two first narrowing portions 263 of the two signal terminals 26. A width of the expanding portion 261 is wider than a width of the main body 262. The width of the main body 262 is wider than a width of the first narrowing portion 263. The width of the first narrowing portion 263 is wider than a width of the second narrowing portion 264. The width of the second narrowing portion 264 is equal to the width of the soldering portion 235.

The insulating body 24 of the dielectric body 204 has a plurality of assembling holes 241, a plurality of penetrating holes 242, a plurality of first concave portions 243, a plurality of second concave portions 244 and a plurality of protruding blocks 245. Several portions of two top ends of two inner surfaces of the dielectric body 204 are recessed oppositely to form the plurality of the assembling holes 241. Several portions of two top ends of two inner surfaces of the two insulating bodies 24 of the two terminal modules 201 are recessed oppositely to form the plurality of the assembling holes 241. The plurality of the assembling holes 241 are corresponding to the plurality of the first curve portions 251 of the plurality of the grounding terminals 25 of the terminals 23 of the two terminal modules 201. The plurality of the first curve portions 251 of the plurality of the grounding terminals 25 are disposed in the plurality of the assembling holes 241. Corresponding sections of the conductive glue body 3 are fastened in the plurality of the assembling holes 241 to realize that the conductive glue body 3 is located in the terminal assembly 2, and that the conductive glue body 3 is fastened in the terminal assembly 2. The corresponding sections of the conductive glue body 3 electrically contact with the plurality of the first curve portions 251 of the plurality of the grounding terminals 25, so the high-frequency characteristic of the electrical connector 100 is improved.

Several portions of two top ends of two outer surfaces of the dielectric body 204 are recessed inward to form the plurality of the penetrating holes 242. Several portions of a top end of an outer surface of the insulating body 24 are recessed inward to form the plurality of the penetrating holes 242. The plurality of the penetrating holes 242 are corresponding to the plurality of the assembling holes 241. The plurality of the penetrating holes 242 are corresponding to plurality of the first curve portions 251 of the plurality of the grounding terminals 25. The plurality of the first curve portions 251 of the plurality of the grounding terminals 25 are disposed in the plurality of the penetrating holes 242. In a manufacturing process, a plurality of propping elements of a mold (not shown) pass through the plurality of the penetrating holes 242, and then the plurality of the propping elements support the plurality of the first curve portions 251 of the plurality of the grounding terminals 25. In the preferred embodiment, an aperture of each assembling hole 241 is bigger than an aperture of each penetrating hole 242. In the concrete implementation, the aperture of each assembling hole 241 is without being limited to be bigger than the aperture of each penetrating hole 242.

Several portions of the two inner surfaces of the dielectric body 204 are recessed outward to form the plurality of the first concave portions 243. Several portions of the two inner surfaces of the two insulating bodies 24 are recessed outward to form the plurality of the first concave portions 243. Each two adjacent first concave portions 243 are separated by one or two assembling holes 241. The plurality of the fastening portions 231 of the plurality of the signal terminals 26 of the plurality of the terminals 23 of the terminal assembly 2 are disposed in the plurality of the first concave portions 243. The plurality of the first concave portions 243 are used for adjusting the high-frequency characteristic of the electrical connector 100.

Several portions of two outer surfaces of the dielectric body 204 are recessed inward to form the plurality of the second concave portions 244. The outer surface of the insulating body 24 defines the plurality of the second concave portions 244 recessed inward. Each two adjacent second concave portions 244 are separated by one penetrating hole 242, two penetrating holes 242 or three penetrating holes 242. The plurality of the second concave portions 244 are corresponding to the plurality of the first concave portions 243. The plurality of the fastening portions 231 of the plurality of the signal terminals 26 are disposed in the plurality of the second concave portions 244. The plurality of the second concave portions 244 are used for adjusting the high-frequency characteristic of the electrical connector 100. In the preferred embodiment, a length of each second concave portion 244 is longer than a length of each first concave portion 243. In the concrete implementation, the length of each second concave portion 244 is without being limited to be longer than the length of each first concave portion 243. The length of each second concave portion 244 and the length of each first concave portion 243 are adjusted according to a high-frequency characteristic requirement of the electrical connector 100.

Several portions of a bottom end of the outer surface of the insulating body 24 extend outward to form the plurality of the protruding blocks 245. Each protruding block 245 is formed between two second concave portions 244. The plurality of the protruding blocks 245 are formed under the plurality of the penetrating holes 242. The plurality of the protruding blocks 245 are fastened in the plurality of the openings 11 of the insulating housing 1 to realize that the terminal assembly 2 is located in the insulating housing 1, and that the terminal assembly 2 is fastened in the insulating housing 1. In the preferred embodiment, the structure of the second terminal module 22 is roughly the same as the structure of the first terminal module 21. The second terminal module 22 is without being described in detail.

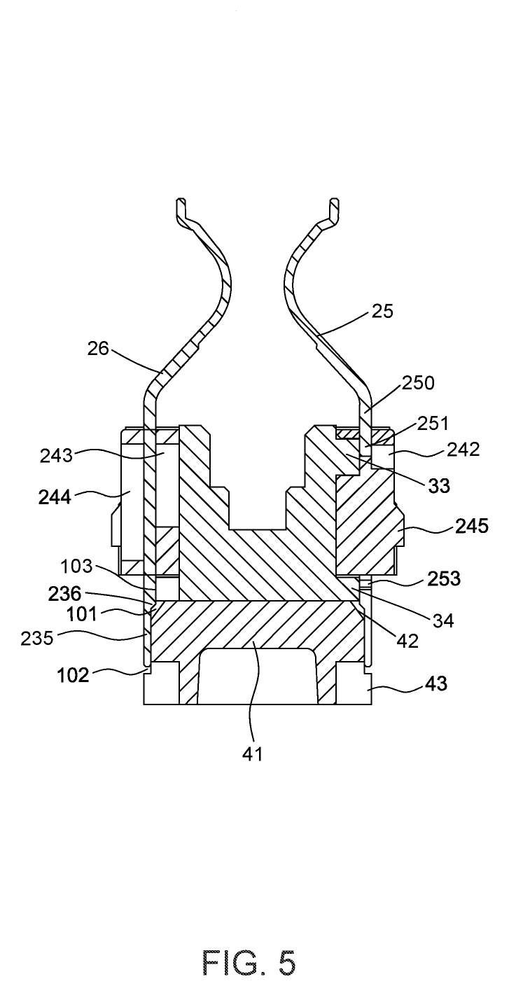

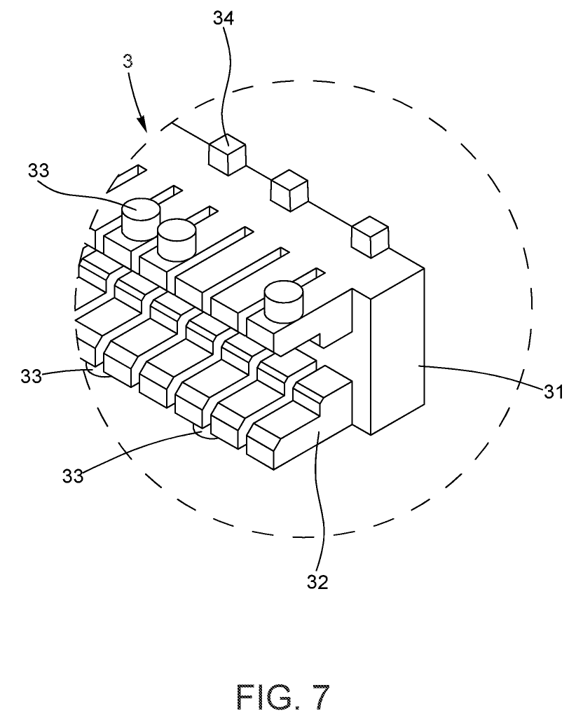

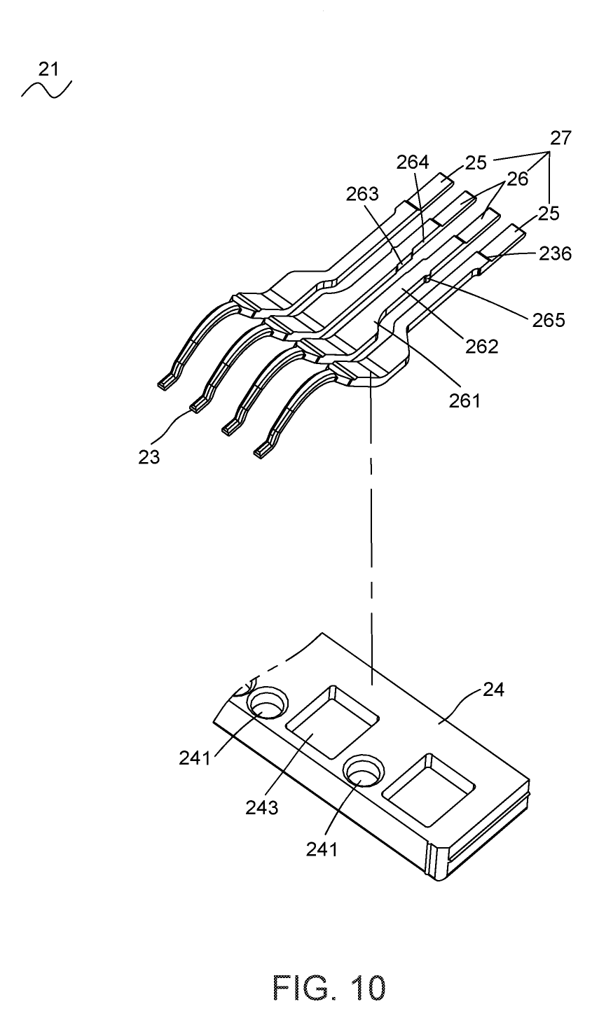

Referring to FIG. 5, FIG. 7 and FIG. 10, the conductive glue body 3 has a base body 31, a plurality of column portions 32, a plurality of upper convex portions 33, a plurality of lower convex portions 34 and at least one location hole 35. In the preferred embodiment, the conductive glue body 3 is made of a conductive plastic material. The conductive glue body 3 has two location holes 35 formed on a bottom surface of the conductive glue body 3 along the up-down direction. Two opposite sides of a top surface of the base body 31 extend upward to form the plurality of the column portions 32. The plurality of the column portions 32 are longitudinally arranged in two rows.

In the preferred embodiment, each column portion 32 is shown as a step shape. A thickness of a top of each column portion 32 is narrower than a thickness of a bottom of each column portion 32. The two insulating bodies 24 of the terminal assembly 2 are disposed to two opposite outer surfaces of the base body 31 and outer surfaces of the plurality of the column portions 32. Top ends of two opposite outer surfaces of the conductive glue body 3 protrude outward to form the plurality of the upper convex portions 33. Bottom ends of the two opposite outer surfaces of the conductive glue body 3 protrude outward to form the plurality of the lower convex portions 34.

Each column portion 32 is corresponding to one terminal 23 of the terminal assembly 2 along the longitudinal direction. Top ends of the outer surfaces of the plurality of the column portions 32 which are corresponding to the plurality of the grounding terminals 25 protrude outward to form the plurality of the upper convex portions 33. Each upper convex portion 33 is shown as a column shape. The plurality of the first curve portions 251 of the plurality of the grounding terminals 25 are electrically connected with the plurality of the upper convex portions 33, so the high-frequency characteristic of the electrical connector 100 is improved. The plurality of the upper convex portions 33 are fastened in the plurality of the assembling holes 241 of the two insulating bodies 24 of the dielectric body 204 to realize that the conductive glue body 3 is located in the terminal assembly 2, and that the conductive glue body 3 is fastened in the terminal assembly 2.

Bottom ends of the two opposite outer surfaces of the base body 31 extend outward to form the plurality of the lower convex portions 34. The plurality of the lower convex portions 34 are disposed under the dielectric body 204. The two insulating bodies 24 of the terminal assembly 2 are located above the plurality of the lower convex portions 34. The plurality of the second curve portions 253 of the plurality of the grounding terminals 25 are electrically connected with the plurality of the lower convex portions 34, so the high-frequency characteristic of the electrical connector 100 is improved. The plurality of the inclining portions 236 of the plurality of the terminals 23 of the terminal assembly 2 extend beyond bottom ends of the plurality of the lower convex portions 34. The plurality of the inclining portion 236 of the plurality of the terminals 23 of the terminal assembly 2 are located near the bottom ends of the plurality of the lower convex portions 34.

A bottom of the conductive glue body 3 defines the two location holes 35 penetrating through a bottom surface of the conductive glue body 3. Corresponding mechanisms of the supporting body 4 are fastened in the two location holes 35 to realize that the supporting body 4 is located in the conductive glue body 3, and that the supporting body 4 is fastened in the conductive glue body 3.

Referring to FIG. 5 and FIG. 7, the supporting body 4 has a plate body 41, two chamfers 42, a plurality of protruding portions 43 and at least one locating pillar 44. In the preferred embodiment, the supporting body 4 has two locating pillars 44. The plurality of the soldering portions 235 of the plurality of the terminals 23 of the terminal assembly 2 are disposed to two opposite outer surfaces of the plate body 41. Top ends of the two opposite outer surfaces of the plate body 41 slantwise extend inward and upward to form the two chamfers 42. The plurality of the inclining portions 236 of each row of the terminal assembly 2 are spaced from one chamfer 42 to form an avoiding space 101 between the plurality of the inclining portions 236 of the row of the terminal assembly 2 and the one chamfer 42. The plurality of the inclining portions 236 of the plurality of the terminals 23 of each terminal module 201 are spaced from the one chamfer 42 to form the avoiding space 101 between the plurality of the inclining portions 236 of the plurality of the terminals 23 of the terminal module 201 and the one chamfer 42. The avoiding space 101 prevents the supporting body 4 colliding with the terminal assembly 2, and a damage of the supporting body 4 and the terminal assembly 2 is accordingly prevented.

Several portions of bottom ends of the two opposite outer surfaces of the plate body 41 extend outward to form the plurality of the protruding portions 43. Bottom ends of the plurality of the soldering portions 235 of the plurality of the terminals 23 of each terminal module 201 of the terminal assembly 2 are spaced from upper portions of the plurality of the protruding portions 43 of one outer surface of the plate body 41 to form a gap 102 between the bottom ends of the plurality of the soldering portions 235 of the plurality of the terminals 23 of the terminal module 201 of the terminal assembly 2 and the upper portions of the plurality of the protruding portions 43 of the one outer surface of the plate body 41. The gap 102 prevents the supporting body 4 colliding with the terminal assembly 2, and the damage of the supporting body 4 and the terminal assembly 2 is accordingly prevented. Two sides of a top surface of the plate body 41 extend upward to form the two locating pillars 44. The two locating pillars 44 are fastened in the two location holes 35 of the conductive glue body 3 to realize that the supporting body 4 is located in the conductive glue body 3, and that the supporting body 4 is fastened in the conductive glue body 3.

The top surface of the plate body 41 of the supporting body 4 abuts against a bottom surface of the base body 31 of the conductive glue body 3. The two insulating bodies 24 of the two terminal modules 201 of the terminal assembly 2 are attached to the two opposite outer surfaces of the base body 31 and the outer surfaces of the plurality of the column portions 32. A bottom surface of the dielectric body 204 is spaced from a top surface of the supporting body 4 to form a mounting space 103 between the bottom surface of the dielectric body 204 and the top surface of the supporting body 4. Bottom surfaces of the two insulating bodies 24 of the two terminal modules 201 of the terminal assembly 2 are spaced from the top surface of the supporting body 4 to form the mounting space 103 between the bottom surfaces of the two insulating bodies 24 of the two terminal modules 201 of the terminal assembly 2 and the top surface of the supporting body 4. The plurality of the lower convex portions 34 of the conductive glue body 3 are disposed in the mounting space 103. Bottom surfaces of the plurality of the lower convex portions 34 of the conductive glue body 3 abut against the top surface of the supporting body 4. Top surfaces of the plurality of the lower convex portions 34 of the conductive glue body 3 are corresponding to the bottom surfaces of the two insulating bodies 24 of the two terminal modules 201 of the terminal assembly 2.

As described above, the electrical connector 100 improves the high-frequency characteristic of the electrical connector 100 by structure designs of the plurality of the differential terminal assemblies 27. A bottom end of the bending portion 232 of each grounding terminal 25 extends downward to form the top portion 250. The top portion 250 extends out of the top end of the insulating body 24 of the dielectric body 204. A bottom end of the top portion 250 is connected with the first curve portion 251. The first curve portion 251 is disposed in the insulating body 24 of the dielectric body 204. A bottom end of the first curve portion 251 is connected with the base portion 252. The base portion 252 is disposed in the insulating body 24 of the dielectric body 204. The bottom end of the base portion 252 is connected with the second curve portion 253. The second curve portion 253 extends out of the bottom end of the insulating body 24. The bottom end of the second curve portion 253 extends downward to form the soldering portion 235. In addition, the electrical connector 100 improves the high-frequency characteristic by a structure design of the conductive glue body 3. The conductive glue body 3 has the plurality of the upper convex portions 33 and the plurality of the lower convex portions 34. The plurality of the first curve portions 251 of the plurality of the grounding terminals 25 are electrically connected with the plurality of the upper convex portions 33, so the high-frequency characteristic of the electrical connector 100 is improved. The plurality of the second curve portions 253 of the plurality of the grounding terminals 25 are electrically connected with the plurality of the lower convex portions 34, so the high-frequency characteristic of the electrical connector 100 is improved.

What is claimed is:

1. An electrical connector, comprising:
an insulating housing;
a terminal assembly fastened in the insulating housing, the terminal assembly having a dielectric body, a plurality of signal terminals and a plurality of grounding terminals fastened in the dielectric body, each grounding terminal having a contacting portion, a top portion, a first curve portion, a base portion, a second curve portion and a soldering portion, the contacting portion and the top portion extending out of a top end of the dielectric body, the first curve portion and the base portion being fastened in the dielectric body, the second curve portion and the soldering portion extending out of a bottom end of the dielectric body, several portions of two top ends of two inner surfaces of the dielectric body being recessed oppositely to form a plurality of assembling holes; and
a conductive glue body disposed in a middle of the terminal assembly, top ends of two opposite outer surfaces of the conductive glue body protruding outward to form a plurality of upper convex portions, bottom ends of the two opposite outer surfaces of the conductive glue body protruding outward to form a plurality of lower convex portions, the plurality of the upper convex portions being fastened in the plurality of the assembling holes, the plurality of the lower convex portions being disposed under the dielectric body, the plurality of the first curve portions of the plurality of the grounding terminals being electrically connected with the plurality of the upper convex portions, the plurality of the second curve portions of the plurality of the grounding terminals being electrically connected with the plurality of the lower convex portions.

2. The electrical connector as claimed in claim 1 wherein each of the plurality of the signal terminals and the grounding terminals has a fastening portion, the fastening portion of each grounding terminal has the top portion, the first curve portion, the base portion and the second curve portion, a top end of the base portion is bent outward and then extends upward to form the first curve portion, a top end of the first curve portion extends upward to form the top portion, the bottom end of the base portion extends downward and protrudes outward to form the second curve portion.

3. The electrical connector as claimed in claim 2 wherein a bottom end of the second curve portion extends downward to form the soldering portion, the second curve portion is connected between the base portion and the soldering portion, a bottom end of an inner surface of the soldering portion is recessed outward, and then slantwise extends inward and upward to form an inclining portion, the plurality of the inclining portions of the terminal assembly extend beyond bottom ends of the plurality of the lower convex portions.

4. The electrical connector as claimed in claim 3 wherein a width of the top portion is wider than a width of the first curve portion, the width of the top portion is wider than a width of the soldering portion, a width of the first curve portion is wider than a width of the base portion, the width of the soldering portion is wider than the width of the base portion.

5. The electrical connector as claimed in claim 3 further comprising a supporting body disposed to a bottom surface of the conductive glue body, the supporting body being disposed to a middle of a bottom end of the terminal assembly, the supporting body having a plate body, a plurality of the soldering portions of the terminal assembly being disposed to two opposite outer surfaces of the plate body.

6. The electrical connector as claimed in claim 5 wherein top ends of the two opposite outer surfaces of the plate body slantwise extend inward and upward to form two chamfers, the terminal assembly has two terminal modules longitudinally arranged into two rows, the plurality of the inclining portions of each row of the terminal modules are spaced from one chamfer to form an avoiding space between the plurality of the inclining portions of the row of the terminal modules and the one chamfer.

7. The electrical connector as claimed in claim 6 wherein the fastening portion of each signal terminal has a main body, a top end of the main body of the fastening portion of each signal terminal is extended outward, and then extends upward and protrudes outward to form an expanding portion, the expanding portion and the first curve portion of the grounding terminal are aligned along a transverse direction.

8. The electrical connector as claimed in claim 7 wherein each two adjacent signal terminals are located between two grounding terminals, two facing edges of two bottom ends of the two main bodies of the two fastening portions of the two signal terminals are recessed oppositely and extend downward to form two first narrowing portions, two facing edges of two bottom ends of the two first narrowing portions are recessed oppositely and extend downward to form two second narrowing portions, a bottom end of each second narrowing portion extends downward to form the soldering portion, the first narrowing portion and second narrowing portion of each signal terminal are aligned an upper portion of the second curve portion of each grounding terminal.

9. The electrical connector as claimed in claim 8 wherein a middle of an outer surface of the fastening portion of each signal terminal protrudes outward to form a protrusion, the protrusion is fastened in the dielectric body, the two protrusions are disposed to two outer sides of the two first narrowing portions.

10. The electrical connector as claimed in claim 9 wherein a width of the expanding portion is wider than a width of the main body, the width of the main body is wider than a width of the first narrowing portion, the width of the first narrowing portion is wider than a width of the second narrowing portion, the width of the second narrowing portion is equal to a width of the soldering portion.

11. The electrical connector as claimed in claim 5 wherein a bottom surface of the dielectric body is spaced from a top surface of the supporting body to form a mounting space between the bottom surface of the dielectric body and the top surface of the supporting body, the plurality of the lower convex portions of the conductive glue body are disposed in the mounting space.

12. The electrical connector as claimed in claim 5 wherein several portions of bottom ends of the two opposite outer surfaces of the plate body extend outward to form a plurality of protruding portions, bottom ends of the plurality of the soldering portions of the terminal assembly are spaced from upper portions of the plurality of the protruding portions of one outer surface of the plate body to form a gap between the bottom ends of the plurality of the soldering portions of the terminal assembly and the upper portions of the plurality of the protruding portions of the one outer surface of the plate body.

13. The electrical connector as claimed in claim 1 wherein the conductive glue body has a base body, two opposite sides of a top surface of the base body extend upward to form a plurality of column portions, top ends of outer surfaces of the plurality of the column portions which are corresponding to the plurality of the grounding terminals protrude outward to form the plurality of the upper convex portions, bottom ends of two opposite outer surfaces of the base body extend outward to form the plurality of the lower convex portions.

14. The electrical connector as claimed in claim 2 wherein several portions of two top ends of two outer surfaces of the dielectric body are recessed inward to form a plurality of the penetrating holes, the plurality of the penetrating holes are corresponding to the plurality of the assembling holes, the plurality of the penetrating holes are corresponding to plurality of the first curve portions of the plurality of the grounding terminals, the plurality of the first curve portions of the plurality of the grounding terminals are disposed in the plurality of the penetrating holes.

15. The electrical connector as claimed in claim 14 wherein an aperture of each assembling hole is bigger than an aperture of the penetrating hole.

16. The electrical connector as claimed in claim 14 wherein several portions of the two inner surfaces of the dielectric body are recessed outward to form a plurality of first concave portions, each two adjacent first concave portions are separated by one assembling hole or two assembling holes, the plurality of the fastening portions of the plurality of the signal terminals of the terminal assembly are disposed in the plurality of the first concave portions.

17. The electrical connector as claimed in claim 16 wherein several portions of two outer surfaces of the dielectric body are recessed inward to form a plurality of second concave portions, each two adjacent second concave portions are separated by one penetrating hole, two penetrating holes or three penetrating holes, the plurality of the second concave portions are corresponding to the plurality of the first concave portions, a plurality of the fastening portions of the plurality of the signal terminals are disposed in the plurality of the second concave portions.

18. The electrical connector as claimed in claim 1 wherein the conductive glue body is made of a conductive plastic material.

19. An electrical connector, comprising:
an insulating housing;
a terminal assembly disposed in the insulating housing, the terminal assembly including a dielectric body, a plurality of signal terminals and a plurality of grounding terminals fastened in the dielectric body, each grounding terminal having a contacting portion, a top portion, a first curve portion, a base portion, a second curve portion and a soldering portion, the contacting portion and the top portion extending out of a top end of the dielectric body, the first curve portion and the base portion being fastened in the dielectric body, the second curve portion and the soldering portion extending out of a bottom end of the dielectric body; and
a conductive glue body disposed in a middle of the terminal assembly, the conductive glue body having a base body, two opposite sides of a top surface of the base body extending upward to form a plurality of column portions, top ends of the outer surfaces of the plurality of the column portions which are corresponding to the plurality of the grounding terminals protruding outward to form a plurality of upper convex portions, bottom ends of the two opposite outer surfaces of the base body extending outward to form a plurality of lower convex portions, the plurality of the upper convex portions being fastened in the dielectric body, the plurality of the lower convex portions being disposed under the dielectric body, the plurality of the first curve portions of the plurality of the grounding terminals being electrically connected with the plurality of the upper convex portions, the plurality of the second curve portions of the plurality of the grounding terminals being electrically connected with the plurality of the lower convex portions.

20. An electrical connector, comprising:
an insulating housing;
a terminal assembly disposed in the insulating housing, the terminal assembly having a dielectric body, a plurality of signal terminals and a plurality of grounding terminals fastened in the dielectric body, each grounding terminal and each signal terminal having a fastening portion, a bending portion, a connecting portion, a contacting portion, a soldering portion, the bending portion, the connecting portion and the contacting portion extending out of a top end of the dielectric body, the fastening portion being fastened in the dielectric body, a bottom of the fastening portion and the soldering portion extending out of a bottom end of the dielectric body;
a conductive glue body disposed in a middle of the terminal assembly, top ends of two opposite outer surfaces of the conductive glue body protruding outward to form a plurality of upper convex portions, bottom ends of the two opposite outer surfaces of the conductive glue body protruding outward to form a plurality of lower convex portions, the plurality of the upper convex portions being fastened in the dielectric body, the plurality of the lower convex portions being disposed under the dielectric body, tops of the fastening portions of the plurality of the grounding terminals being electrically connected with the plurality of the upper convex portions, the bottoms of the fastening portions of the plurality of the grounding terminals being electrically connected with the plurality of the lower convex portions; and
a supporting body disposed to a bottom of the conductive glue body, the supporting body being disposed to a bottom end of the terminal assembly, a bottom surface of the dielectric body being spaced from a top surface of the supporting body to form a mounting space between the bottom surface of the dielectric body and the top surface of the supporting body, the plurality of the lower convex portions being disposed in the mounting space.
